(19) United States
(12) Patent Application Publication
(10) Pub. No.: US 2020/0242707 A1
(43) Pub. Date: Jul. 30, 2020

(54) System and Method for Generating Networking Referrals

(71) Applicant: Conor Cappa, San Diego, CA (US)

(72) Inventor: Conor Cappa, San Diego, CA (US)

(21) Appl. No.: 16/776,459

(22) Filed: Jan. 29, 2020

Related U.S. Application Data
(60) Provisional application No. 62/797,970, filed on Jan. 29, 2019.

(51) Int. Cl. G06Q 50/00; G06N 20/00; G06Q 10/10; G06N 5/04

(52) U.S. Cl. CPC G06Q 50/01; G06N 5/04; G06Q 10/1095; G06N 20/00

(57) ABSTRACT

Apparatus and associated methods relate to generating a user referral to a potential networking contact, based on referral parameters ranked as a function of the user's networking goal, in response to user networking activity, and at a location and time based on the user networking activity. In an illustrative example, the referral parameters may be a desired skill set. The user's networking goal may be, for example, connecting with potential contacts having the desired skill set, permitting the user and contact to network. In some examples, the generated referral may include a restaurant coupon configured to encourage a meetup in real life. Some embodiments may rank potential contacts based on their importance to achieving the user's networking goal. Various examples may advantageously generate referrals to achieve the user's networking goal in response to user networking activity and potential networking contact availability and interest at a mutually beneficial location and time.

### CROSS-REFERENCE TO RELATED APPLICATIONS

This application claims the benefit of U.S. Provisional Application No. 62/797,970, titled “System and Method for Providing Networking Referrals,” filed by Conor Cappa on 29 Jan. 2019.

This application incorporates the entire contents of the above-referenced application herein by reference.

### TECHNICAL FIELD

Various embodiments relate generally to professional networking, specifically generating referrals and facilitating and coordinating networking connections and meetings for busy professionals.

### BACKGROUND

A professional network is group of professionals connected by common business interests. Some business people engage in professional networking activities to find and maintain relationships with other professionals. In an illustrative example, professionals may engage in networking activity to find a job, stay up to date with current trends in their industry, or find a person with a specific skill set for a job role in their company.

A professional may be connected to many other professionals through various professional networks. In some examples, a professional's network connection to another professional in the network may be defined by the connection degree. For example, a professional may be directly connected to first degree connections, but may have second or third degree connections that are not direct connections. In an illustrative example, some professionals may know or trust their first degree connections more than higher-degree connections. For example, a networking professional may have high confidence in another professional referred by a first degree connection who they have worked closely with.

Examples of professional networking activity include initiating contact with another professional through social media or a professional networking application, attending networking events such as conferences in real life, or informally meeting up with colleagues. Some networking activities may be directed to obtaining a referral, or introduction, to network with and potentially connect with professionals that are well positioned in an industry or business community. Professionals seeking networking referrals or introductions may expend significant time and effort identifying, selecting, and arranging referrals to new professional networking contacts.

### SUMMARY

Apparatus and associated methods relate to generating a user referral to a potential networking contact, based on referral parameters ranked as a function of the user's networking goal, in response to user networking activity, and at a location and time based on the user networking activity. In an illustrative example, the referral parameters may be a desired skill set. The user's networking goal may be, for example, connecting with potential contacts having the desired skill set, permitting the user and contact to network. In some examples, the generated referral may include a restaurant coupon configured to encourage a meetup in real life. Some embodiments may rank potential contacts based on their importance to achieving the user's networking goal. Various examples may advantageously generate referrals to achieve the user's networking goal in response to user networking activity and potential networking contact availability and interest at a mutually beneficial location and time.

Various embodiments may achieve one or more advantages. For example, some embodiments may improve a user's ease of access to professional networking referrals. This facilitation may be a result of reducing the user's effort arranging and scheduling meetups with potential networking contacts in the user's industry. In some embodiments, networking referrals and introductions may be automatically generated to achieve a user's networking goals. Such automatic goal-directed networking referral generation may reduce a user's exposure to lost time and wasted resources seeking referrals to potential networking contacts. Some embodiments may reduce a user's effort scheduling networking meetups with selected potential professional networking contacts. Such reduced professional networking scheduling effort may be a result of an embodiment app configured to connect with potential networking candidates' calendars, permitting the users to select free time that users may request to reserve. Some examples may improve the user's professional networking experience. For example, an embodiment app may alert users to public meetups nearby, increasing the user's efficiency locating available professional networking meetups.

Various designs may suggest restaurants, cafes, bars, or other such venues, located in-between professionals that have accepted an offer to meet up, reducing the users' effort locating a suitable meetup location. This facilitation may be a result of an embodiment app configured to permit networking professionals to actively see each other's restaurant selections. Some embodiments may improve revenue of professional networking meetup venues and encourage networking professionals to follow through with real life meetup requests. This facilitation may be a result of an embodiment app configured to send a promotional coupon generated for the selected venue to each user's phone, the selected venue, or one user's phone, depending on venue technologies, when the users are no more than a predetermined distance away from the selected venue. Various implementations may improve the value of the users' professional networking. Such improved professional networking value may be a result of an embodiment app configured to prompt users to review the meetup experience, and opt-in to exchange contact information, based on each user's meetup experience, permitting users to avoid connecting with potential contacts that are not advantageous to achieving the user's networking goal. Some examples may prompt the users' to review the meetup experience, and opt-in to exchange contact information, in response to detecting that the users' phones are at least a predetermined distance away from each other, reducing post-meetup awkwardness related to a meetup that may not have gone well.

The details of various embodiments are set forth in the accompanying drawings and the description below. Other features and advantages will be apparent from the description and drawings, and from the claims.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is an illustrative process flow diagram, in accordance with an embodiment of the present invention.

FIGS. 4A-4I together depict illustrative screen shot views of an exemplary app user interface, in accordance with an embodiment of the present invention.

Like reference symbols in the various drawings indicate like elements.

### DETAILED DESCRIPTION OF ILLUSTRATIVE EMBODIMENTS

Various embodiments relate generally to professional networking, and more specifically to generating networking referrals, and facilitating and coordinating networking connections and meetings for busy professionals.

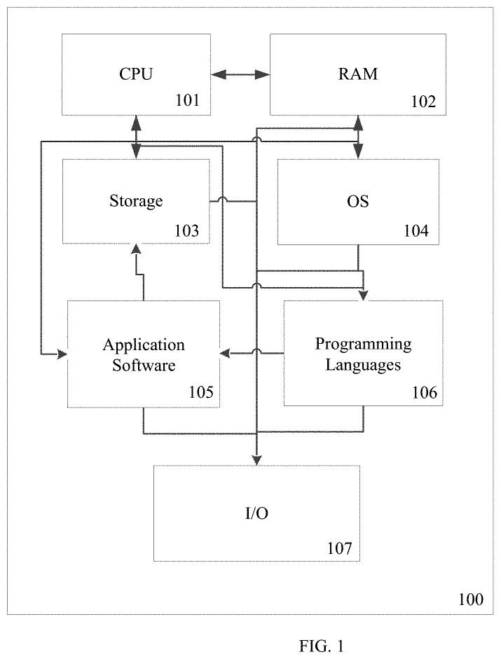

According to an embodiment of the present invention, the system and method is accomplished through the use of one or more computing devices. As shown in FIG. 1, one of ordinary skill in the art would appreciate the exemplary computing device 100 appropriate for use with embodiments of the present application may generally include one or more of a Central Processing Unit (CPU, processor) 101, Random Access Memory (RAM) 102, a storage medium (for example, hard disk drive, solid state drive, flash memory, cloud storage) 103, an Operating System (OS) 104, one or more Application Software 105, and various Programming Languages 106. In various embodiments, the exemplary computing device 100 may include a user interface. In an illustrative example, the user interface may include a display element. In some examples, the display element may be touch sensitive. In the depicted example, the computing device 100 includes the Input/Output (I/O) module 107. In various examples, the I/O module 107 may include one or more input/output devices/means, such as, for example, one or more communication interfaces (for example, RS232, Ethernet, Wifi, Bluetooth, USB). Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (for example, office networks, home networks) or wide area networks (WANs) (for example, the Internet). In accordance with the previous embodiment, the system may be comprised of numerous servers communicatively connected across one or more LANs and/or WANs. One of ordinary skill in the art would appreciate that there are numerous manners in which an embodiment system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

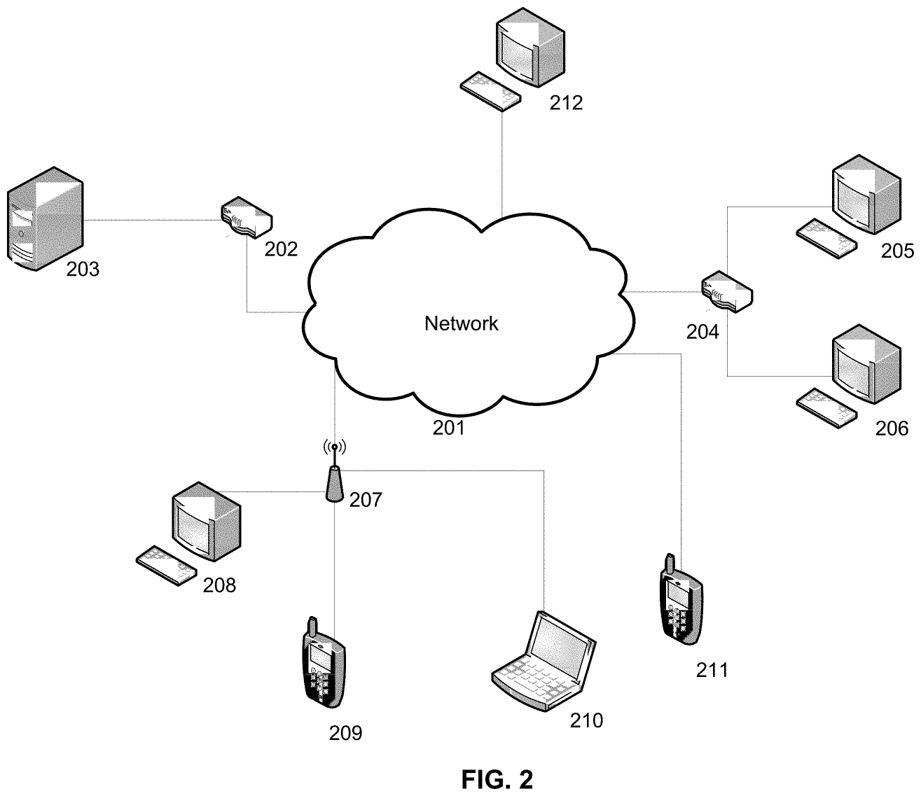

Referring to FIG. 2, a schematic overview of a system in accordance with an embodiment of the present invention is shown. In the depicted embodiment, the exemplary system includes one or more application servers 203 for electronically storing information used by the system. Applications in the server 203 may retrieve and manipulate information in storage devices and exchange information through a WAN 201 (for example, the Internet). Applications in server 203 may also be used to manipulate information stored remotely and process and analyze data stored remotely across a WAN 201 (for example, the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (for example, CDMA, GSM, 3G, 4G, 5G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

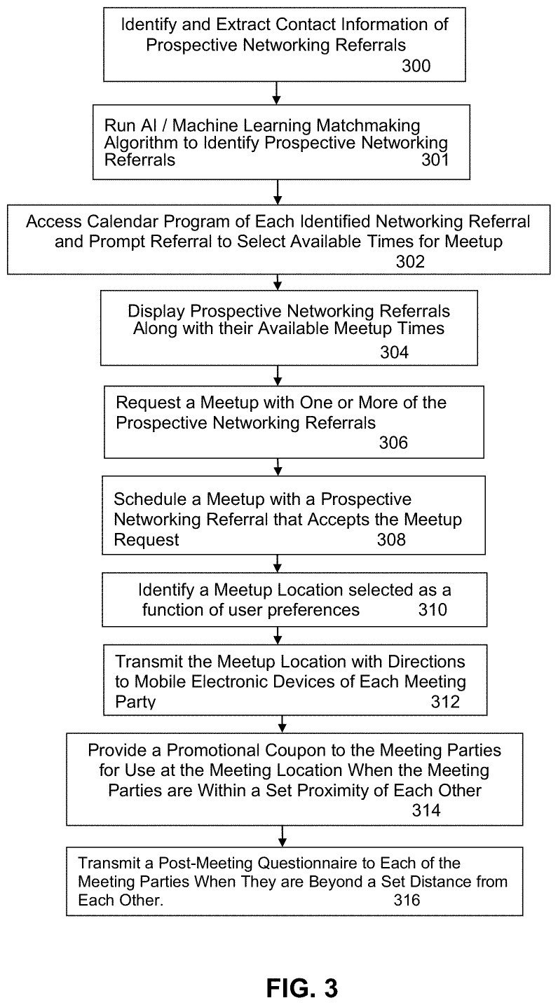

Referring to FIG. 3, in accordance with an embodiment of the present invention, a computing device is provided having one or more processors, memory, and a program module in the form of a software application or “app”, where the program module is stored in the memory and, during operation of the apparatus, is executed by the one or more processors to identify and provide prospective networking referrals to a user and arrange meetings with one or more of the identified networking referrals. FIG. 3 depicts an illustrative process flow diagram exemplary of various embodiment app implementations identifying and generating prospective networking referrals to a user and arranging meetings with one or more of the identified networking referrals. The method depicted by FIG. 3 is given from the perspective of the processor 101 configured in the exemplary computing device disclosed with reference to FIG. 1. In various examples, the app configured in the computing device may be deployed and operated in various modes. In some examples, the app may be configured as a mobile app for an end user. Various embodiments may provide an app configured as a web panel for a venue owner. Some embodiments may include an app adapted as a web admin panel.

The method depicted by FIG. 3 begins at step 300 with the processor 101 identifying and extracting contact information of prospective networking referrals.

The method continues at step 301 with the processor 101 running an Artificial Intelligence (AI)/Machine Learning (ML) based matchmaking algorithm to identify prospective networking referrals.

The method continues at step 302 with the processor 101 accessing a calendar program of each identified networking referral, and prompting each identified referral to select available times for a meetup.

The method continues at step 304 with the processor 101 displaying prospective networking referrals along with their available meetup times.

The method continues at step 306 with the processor 101 requesting a meetup with one or more of the prospective networking referrals.

The method continues at step 308 with the processor 101 scheduling a meetup with a prospective referral that accepts the meetup request.

The method continues at step 310 with the processor 101 identifying a meetup location selected as a function of user preferences. For example, an embodiment app may be configured to match users with an available restaurant based on the type of restaurant the users might prefer.

The method continues at step 312 with the processor 101 transmitting the meetup location to mobile electronic devices of each meeting party.

The method continues at step 314 with the processor 101 providing a promotional coupon to the meeting parties for use at the meeting location when the meeting parties are within a set proximity of each other. In some scenarios wherein the promotional coupon is not used for the meeting, the promotional coupon value may be added to the recipient user's reward points balance for future use.

The method continues at step 316 with the processor 101 transmitting a post-meeting questionnaire to each of the meeting parties when they are beyond a set distance from each other. In various embodiments, the method may repeat.

Although an illustrative example of the disclosed method has been disclosed with reference to FIG. 3, other embodiment methods are possible. For example, in various embodiment implementations, the professional networking application of the present disclosure includes instructions for extracting contact information of prospective networking referrals from a database based, at least in part, on whether the referrals work in a suggested or selected industry. The program module prompts a user to select an industry from a list of pre-populated industries that appear in a user interface of the app. Alternatively, the user enters an industry of interest in an input field appearing in the user interface.

In one embodiment, the app is configured, through its programming instructions, to gather industry information based on a user's inputted professional profile. The networking app then provides a list of suggested industries in which to search for prospective networking referrals. The user can then select one or more preferred industries. Alternatively, the app may simply begin searching for networking referrals in related industries based on the user's inputted profile information without asking the user to select from a list of suggested industries. In any case, once the app has determined one or more related industries to search under, either based on user input, selection, or from a user's profile, the app is configured to extract one or more prospective networking referrals from a database. In one embodiment, the prospective network referrals are organized in the database according to industry, geographic location, proximity to a user's location, company affiliation, or any other useful criteria. Accordingly, the app can extract prospective networking referrals from one or more industries corresponding to industries determined in the previous step. One of ordinary skill in the art will appreciate, that the search may be conducted in related industries, as determined by the program module of the app. In other words, the extract function is not limited to extracting referrals from industries determined in the previous step, but rather can identify and extract networking referrals from the determined industry/industries and any related industries. In addition, the program module of the app may be configured to identify and extract networking referrals based on multiple criteria, such as industry, location, company affiliation, proximity to the user, or any other suitable criteria.

According to an embodiment of the present invention, the program module of the app is configured, through its programming instructions, to access a calendar program residing on a computing device of each of the identified and extracted referrals. Specifically, the app is configured to prompt each prospective networking referral to select available times for a networking meetup. This step of the operation may occur either before or after the app identifies and extracts the prospective networking referrals. In other words, all or some networking referrals may be prompted to provide available times for meetups before a user initiates a search for networking referrals. Alternatively, the app may inquire as to a referral's availability for a meetup only after a user initiates a search and the referral is identified and extracted. The inquiry may appear as a calendar program request, an e-mail request, a text message request, a popup message request, or by some other means of prompting the referral to provide their available times. A person of ordinary skill in the art will recognize that there are many ways to request and gather availability times from a referral, but in all cases, the referral's availability times are posted on the user's personal calendar or another network accessible calendar (that is, accessible to the app).

Although the program module is described in terms of accessing a database of prospective networking referrals, one of ordinary skill will appreciate that that the app may be configured to identify and extract referrals from a plurality of databases that may be located at the same or different locations. In addition, the user may be someone who is seeking networking referrals, but is not a referral him/herself, or may be one of the prospective networking referrals.

According to an embodiment of the present invention, the app is configured, through its programming instructions, to display the identified and extracted prospective networking referrals along with their available meeting times in a user interface of the app. In addition, the computer module is configured to receive a request for a meeting with one or more of the prospective networking referrals. The request may be submitted by clicking or selecting an object representing an available time slot, clicking a box or radio button near the available time slot, or by some other means well known in the art.

According to an embodiment of the present invention, the app is further configured, through its programming instructions, to schedule a meetup with a prospective networking referral that accepts the meetup request. The meetup location may be an agreed-upon location selected from a list of acceptable/preferred locations generated by the app. For example, in one embodiment, both parties (that is, the prospective networking referral, and the user) receive one or more suggested locations to meet, where the suggested locations are generated by the app based on a condition that they are located between (for example, equidistant or approximately equidistant) the meeting parties.

In certain embodiments of the present invention, the system may be configured to allow users to select multiple locations (for example, pick top 3 restaurants the user would prefer), and the system may then pick a location based on the input of locations by the users. In still further embodiments, establishments (for example, bars, restaurants) may be able to pay for featured or preferred listing and selection routines provided to the users.

According to embodiments of the present invention, the referral might select a restaurant from the locations generated by the app and the user can view the selected restaurant. The user can then agree on the selected location by selecting the same restaurant, or select a different location from the suggested locations generated by the app. Similarly, the referral is able to view the user's selection and agree to on the user's selected location by selecting the same location.

According to an embodiment of the present invention, once the location is selected, the system may allow the user and referral to select whether they would like to meet immediately (that is, in the present) or offer the user and referral the ability to schedule a meeting in the future for the location. The system may also be configured to allow for scheduling in the future to be based on availability at the selected location (for example, via reservations)—which may be provided for directly by the system or by way of a third-party API. In other embodiments, the system may inform users if a particular restaurant requires reservations, so that the users can manually make reservations where applicable. In various embodiments, the app may be further configured, through its programming instructions, to transmit the agreed-upon meetup location with directions to the meetup location to computing devices of each respective party. For example, the location and directions can be sent to mobile electronic devices of each meeting party.

According to an embodiment of the present invention, the app is configured, through its programming instructions, to provide a promotional coupon to the meeting parties for use at the meeting location when the parties are within a set proximity of each other. Proximity detection can be accomplished using GPS and/or any available mobile device tracking technology. For example, a restaurant coupon can be e-mailed to the parties when they are within a certain distance of one another (for example, 20 feet of each other, 50 feet of each other, and so forth). Alternatively, the promotional coupon is transmitted to the parties when they are within a set distance from the meeting location. In yet another embodiment, the promotional coupon is transmitted to the parties at a certain amount of time before the scheduled meeting. For example, the promotional coupon can be e-mailed one hour before the scheduled meeting time.

According to embodiment of the present invention, the app is further configured, through its programming instructions, to transmit a post-meeting questionnaire to each of the meeting parties when they are beyond a set distance from each other. For example, when the parties are more than 10 feet away from each other, the app will e-mail a set of questions to each participant. Questions might include: (1) How was the Promo Meetup? (2) Do you want to exchange info? The app may be configured to transmit each party's business card to the other parties at the meeting. This may be done in response to a question such as question (2) above. Alternatively, the questionnaire may be sent a certain amount of time after the meeting is scheduled to end.

According to embodiment of the present invention, the app is further configured to allow the user and referral to share contact information as they reach a set distance away from each other (for example, 50 ft). For instance, the system may provide both the user and the referral the ability to approve sharing of electronic business cards (for example, vCard) with the other, based on whether they wish to continue the relationship beyond the first meeting. The time period for which to exchange contact information can be open ended, or otherwise it may have a temporal limit (for example, sharing must be completed within a 24 hour time period). For each of the embodiments, one of ordinary skill in the art would appreciate that there are numerous time periods and distances that could be used, and embodiments of the present invention are contemplated for use with any appropriate distances or time periods for triggering events.

According to another embodiment of the invention, a computer-system implemented method is provided for identifying prospective networking referrals and arranging meetings with the networking referrals. The method includes extracting contact information of prospective networking referrals from a database based, at least in part, on whether the referrals work in a particular industry. A user may be prompted to select an industry from a list of pre-populated industries that appear in a user interface or the user may enter an industry of interest in an input field appearing in the user interface.

The method further includes accessing a calendar program residing on a computing device of each identified networking referral and prompting each referral to select available times for a networking meetup. The method includes displaying the networking referrals along with their available meeting times to a user of the method. Once the user has reviewed the available times, the method can be used to request a meetup with one or more of the prospective networking referrals.

In response to the user's request for a meetup, the method includes scheduling a meetup with a prospective networking referral that accepts the meetup request. The meetup location may be an agreed-upon location selected from a list of acceptable locations provided by the method. For example, the method includes providing one or more suggested locations based on a condition that the locations are located between the meeting parties. The method further includes receiving a selection of a location from the referral which the user can view. The method similarly receives input from the user agreeing to the selected location, or selection of a different meeting location. The referral is able to view the user's selection and submit input either agreeing to the user's selected location or selecting yet another location.

Once the parties have agreed to the meetup location, the method includes transmitting the meetup location with directions to the meetup location to computing devices of each meeting party. For example, the meetup location and directions can be transmitted by e-mail or text message to a mobile electronic device of each party.

According to an embodiment of the present invention, the method includes providing a promotional coupon for use at the meeting location when the meeting parties are within a set proximity of each other. Alternatively, the coupon may be provided a certain amount of time before the scheduled meeting. For example, the coupon may be provided one hour before the meeting. Finally, the method includes transmitting a post-meeting questionnaire to each of the meeting parties when they are beyond a set distance from each other. Alternatively, the questionnaire may be sent a certain amount of time after the meeting is scheduled to end.

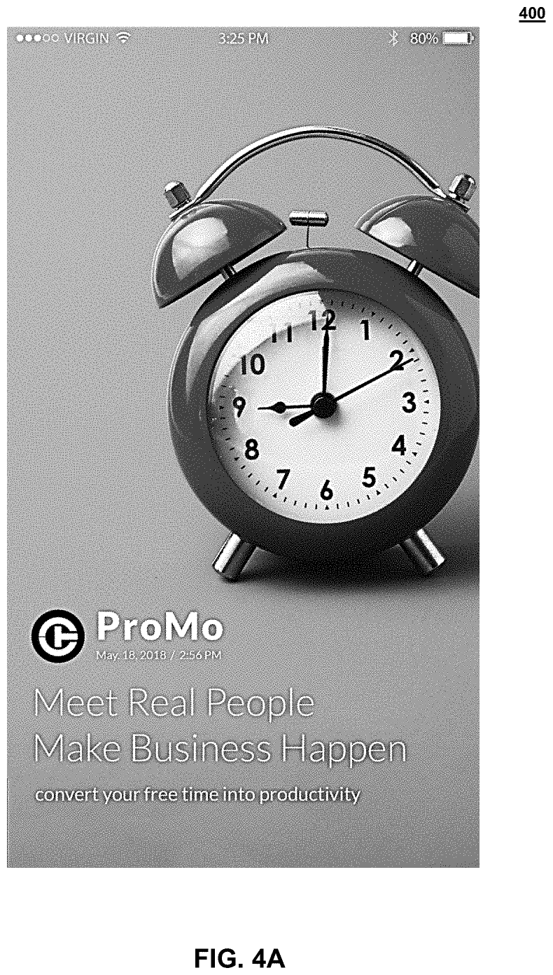

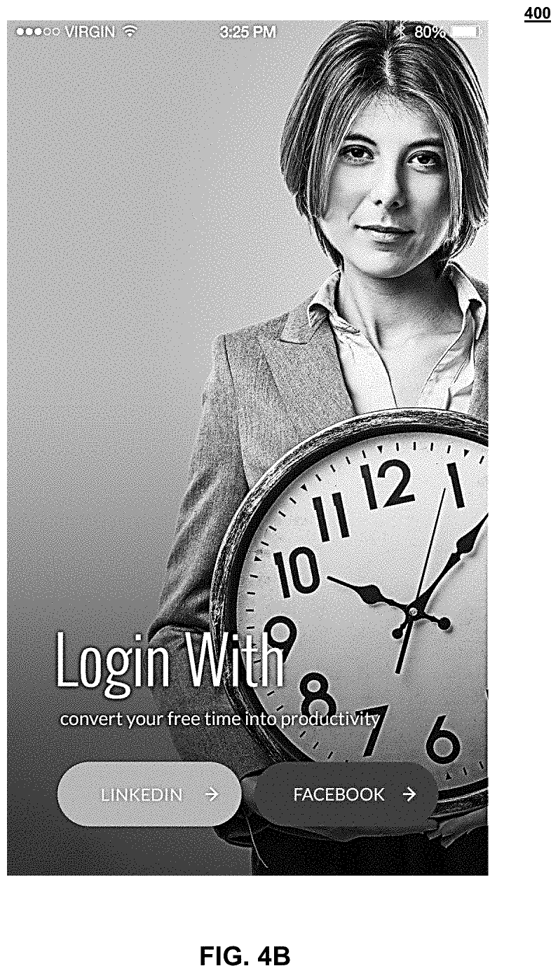

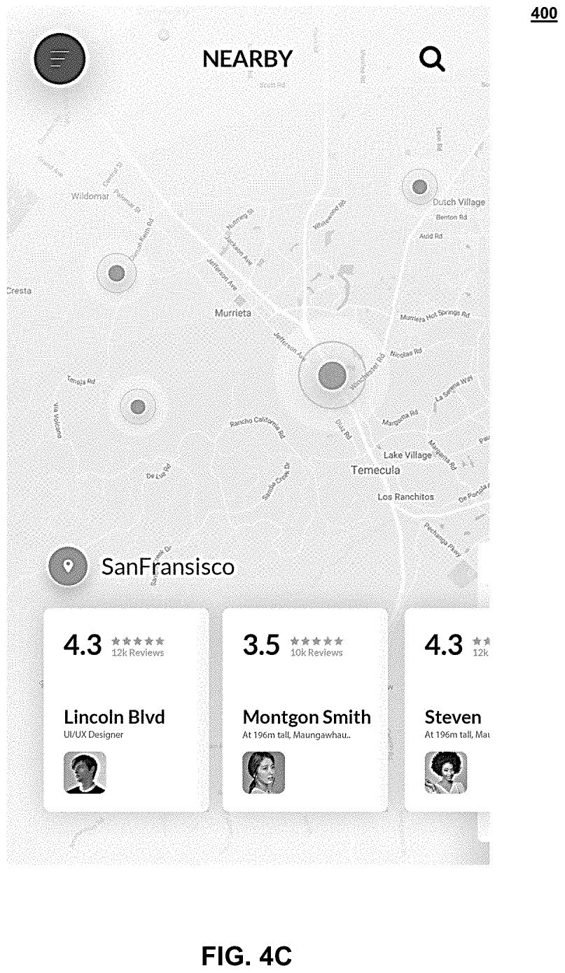

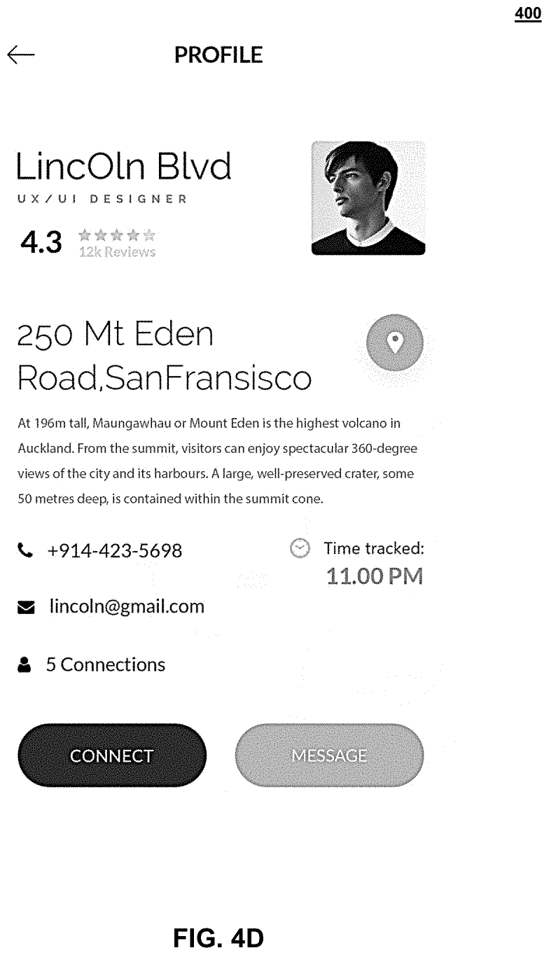

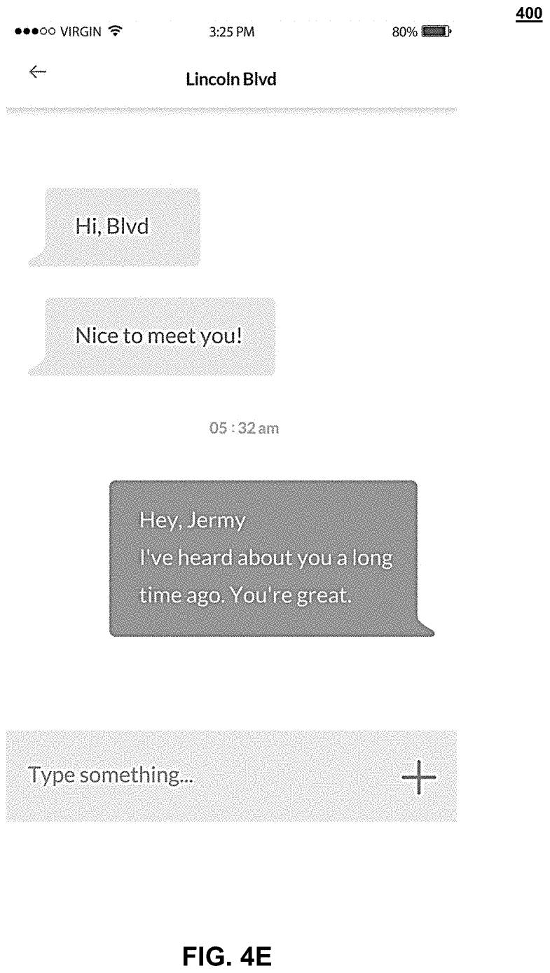

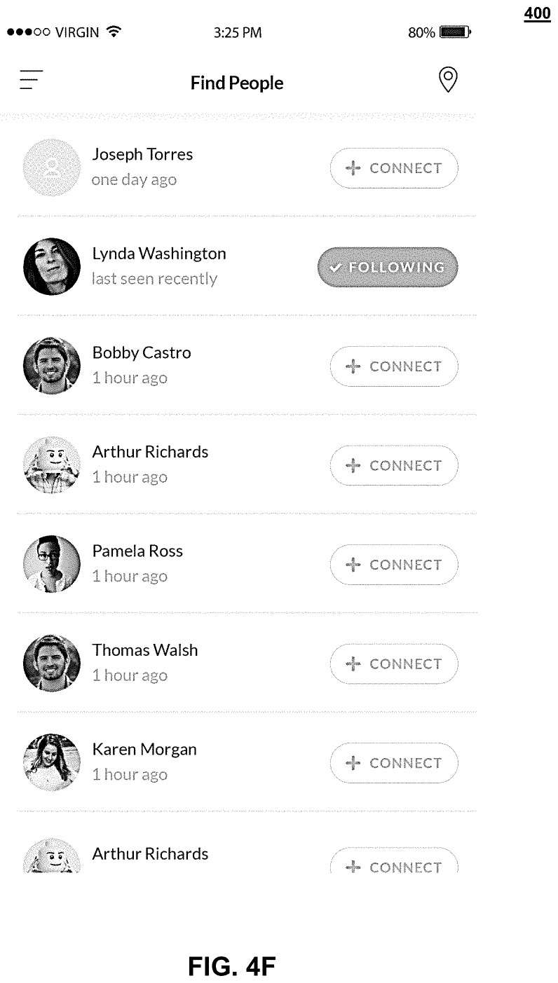

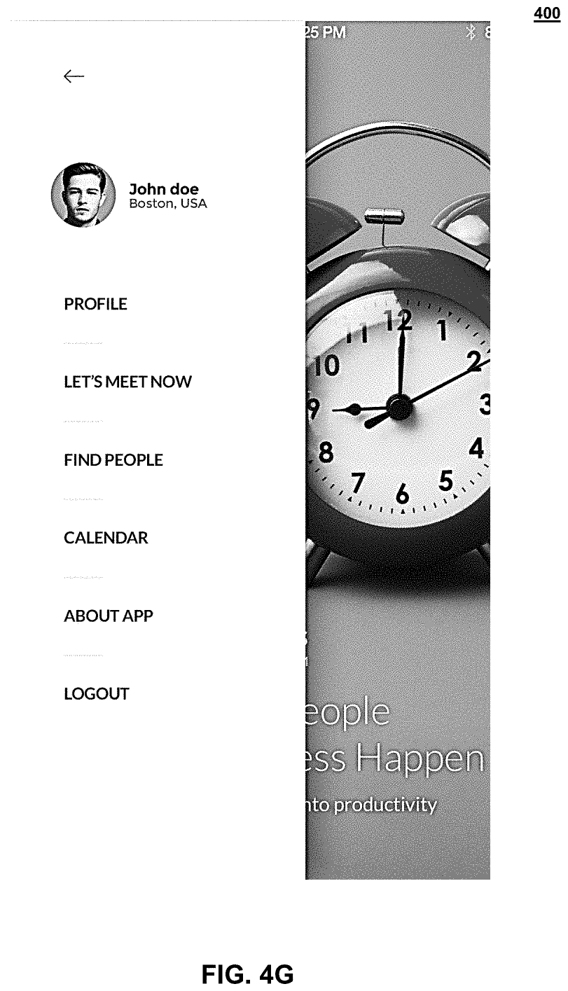

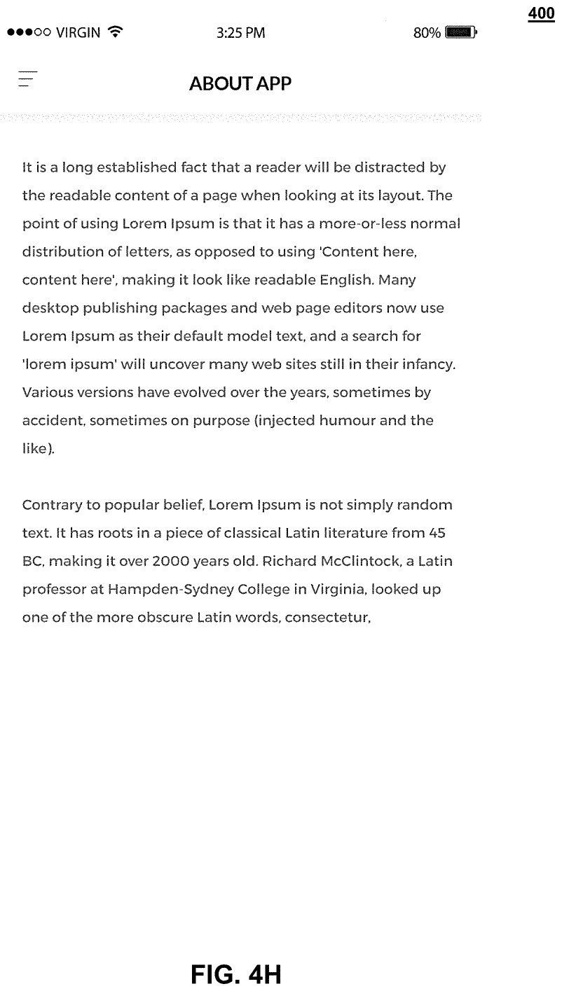

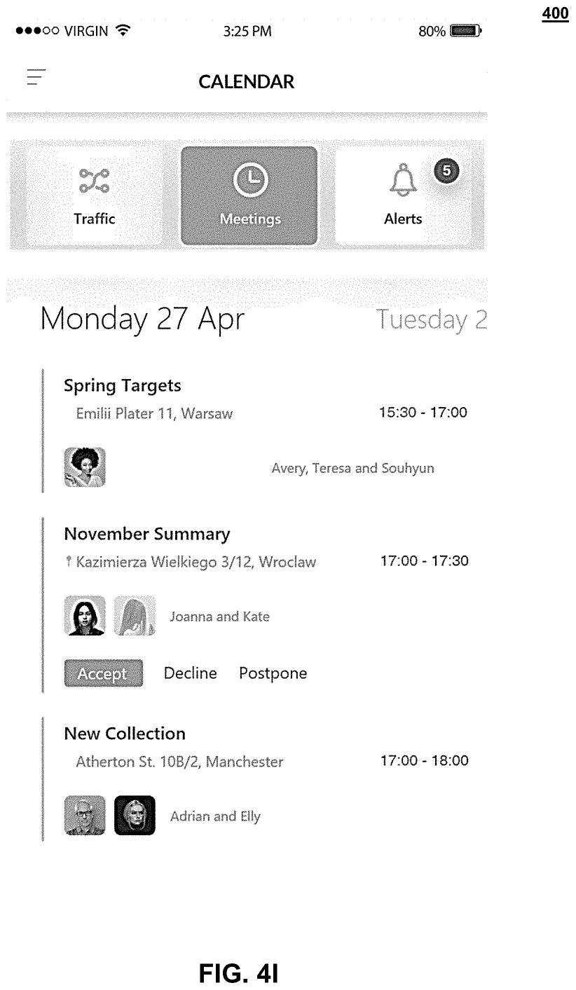

Referring to FIGS. 4A-4I, illustrative screen shot views depict an exemplary professional networking app user interface, in accordance with an embodiment of the present invention.

In FIG. 4A, the exemplary professional networking app user interface 400 is depicted in an illustrative application launch mode displaying an exemplary splash screen.

In FIG. 4B, the exemplary professional networking app user interface 400 is depicted in an illustrative login mode displaying an exemplary login screen. In the illustrated example, the user may login and begin generating referrals and scheduling meetings with various social medial accounts.

In FIG. 4C, the exemplary professional networking app user interface 400 is depicted in an illustrative prospective networking contact location mode displaying an exemplary map annotated with profile links of available prospective contacts that are near the user's present location.

In FIG. 4D, the exemplary professional networking app user interface 400 is depicted in an illustrative networking contact profile presentation mode displaying an exemplary networking contact's profile and rating.

In FIG. 4E, the exemplary professional networking app user interface 400 is depicted in an illustrative networking contact communication mode displaying an exemplary chat screen permitting users to introduce each other and coordinate a meetup.

In FIG. 4F, the exemplary professional networking app user interface 400 is depicted in an illustrative find people mode displaying an exemplary user listing screen.

In FIG. 4G, the exemplary professional networking app user interface 400 is depicted in an illustrative profile access mode displaying an exemplary user profile screen.

In FIG. 4H, the exemplary professional networking app user interface 400 is depicted in an illustrative app help mode displaying an exemplary about app screen configured to present various app administrative, policy, or technical details.

In FIG. 4I, the exemplary professional networking app user interface 400 is depicted in an illustrative schedule mode displaying an exemplary user calendar screen.

Although various embodiments have been described with reference to the Figures, other embodiments are possible. For example, various embodiment implementations may be referred to commercially as PRO-MO Professionals—N-Motion. It is an object of the present disclosure to change the way people think about networking. Various PRO-MO embodiment implementations provide an incentives-based networking application for professionals. Many professionals must make themselves available after work hours for structured networking events where you cannot vet the attendees and can end up wasting your time. If you do meet someone then you must take the time out of another day to meet that person again—coffee, drinks, food, etc. This process is archaic and expensive! The purpose is to transform the entire networking experience into one more time efficient and cost efficient platform.

Various embodiment implementations may determine networking referrals based on a user's networking goal. In some examples, a user's networking goal may be to hire a worker. In various scenarios, a user's networking goal may be general, informal networking socialization. In some examples, a user's networking goal may be to find employment. An embodiment app may select networking referrals based on a user's networking goal by ranking candidate prospective referrals based on skill set, skill level, or importance to achieving a user's networking goal. For example, a user having a goal to meet every marketing manager in a city may provide a list of people they want to meet, or alternatively, the embodiment app may search for the people the user wants to meet, adding each person to a list of desired networking contacts. In some designs, an embodiment app may select for contact potential referrals the user has not met based on the list, with a higher selection priority than referrals the user has met, to enhance the user's ability to achieve their networking goal of meeting all the users in a list of desired referrals. In some designs, an embodiment app may rank potential referrals in priority order to receive a networking invitation based on the user's target skill set or skill level. For example, a hiring manager seeking a highly skilled web developer may restrict networking referrals limiting networking notification requests to the desired skill set and skill level.

Various embodiment App designs show a user professionals & businesses in suggested and selected industries. In illustrative non-limiting examples:
An embodiment App connects to your calendar and allows you to select free time during your day that people can request to reserve.
An embodiment App will alert you to public meetups happening around you
An embodiment App when a PROMO has been accepted will suggest restaurants, cafes, bars in-between the two professionals
The professionals can select which restaurants they are interested in—and each can actively see each other's selections with an indicator next to each venue
Once a venue is selected, directions are sent to each phone.
When Phones are 100 ft away from each other a Promotion is generated to each phone—a coupon for the venue they selected.
After the meetup—once phones are 500 ft away from each other—How was Promo Meetup?
Do you want to exchange info?_YES_NO—Sends Business Card
Businesses may increase revenue marketing themselves on app and being on Venue List
Venue operators may use an embodiment PRO-MO vendor application to upload a promotional offer such as the deal of the day, to be highlighted by an embodiment PRO-MO system in preferred meetup location selection

Technology Stack

In illustrative non-limiting examples, an embodiment app may be implemented using a technology stack similar to the following:
iOS Version (from 10.0 to Latest) iPhone
Android version (lollipop 5.1.1 to Latest) Phone
Server Support
Application Languages (Java, Swift4)
Application Type: Native

Application Modules

In illustrative non-limiting examples, an embodiment app may include a Sign-in/Sign up module configured to permit users/admin to:
Sign in/Sign up [users/admin]
Create profile
Sync with LinkedIn
Set free time/slot
Smart Search
Set Interests
Suggested Venue
Message
Geo Fencing
Contacts
Review & Rating
Promotions & Discount Codes
Notifications

Various embodiment app implementations may be configured to operate in modes including, in non-limiting examples:
Mobile App for End User
Web Panel for Venue Owner
Web Admin Panel

Various embodiment app implementations may be configured to provide Super Admin Features including, in non-limiting examples:
Users management
Venue Management
Time slots Management
Categories Management
Notifications
Charts of Account
Statistics and Analytics

Various embodiment app implementations may be configured to provide a user interface permitting, in non-limiting examples:
User will be able to set his profile
User will be able to add his professional history.
User will set his free time slot respectively.
User will be able to login with his email/phone #
User will also be able to login with his social media account.
User will be able to set his free time slot to meet other people
User will be able to mark his slots status able/disable respectively
User will be also be able to manage according to his timings and predefined slots too.
User will be able to synchronize his LinkedIn
In that, user does not need to add his entire professional experience again
User will set his area of interests
System will be able to show case all of those people by having same interest
User will be able to chat all those selected and requested members for correspondence
User will not need to use phone's chatting system
User will have feature with in the application to maintain record and history.
User will be able to filter people with respect to same field of interests.
Easy to correspond and mark to venue to meet anywhere in state.
User will be able to search people by the following things: Name, Title, Profession type or category
User will be able to view numerous people around him till 50 miles radius
User will be able to view all pointed profiles in map view.
User will be able to find multiple people with in the same profession domain.
By tracking current location, system can easily point out all numerous people with in the radius.
Once the business professional finalized the meeting the system will automatically suggest venue for that respective region.
The person (initiative) will have an option to select any of the suggested venue to meet, either user can also search within the app too.
Venue Owner will be able to set his profile
Venue Owner will have options to maintain their profile
Venue Owner will have an option to manage check in requests
User will be able to create new request to the desired person for meeting.
User will view free time slots for the business person.
Contacts and New user will be sync with mobile network and social accounts,
Admin will be able to manage all users
Admin will be able to add/update/delete any user
Admin will have option to review entire list of users and in detail separately.
Admin will be able to manage all venue owners
Admin will be able to add/update/delete any venue owner
Admin will have an option to track total check-ins and preferable places.
Admin will be able to review all time slots with respect to users
Admin will also view the occupied time slots of different users
Admin will have an option to add/update/delete time slots statuses
Admin will be able to add/update/delete any category.
Admin will be able to review all categories of different professions
User will be able to receive notifications
Admin will be able to review all statistics and analytics for businesses, users, requests and messages.
New Request within the radius
New contact
New Message
Updates sent by the admin
Paid Users/Accounts
Promotion and Discount Cards
Paid Accounts for Venue Owners
Restricted in request [subscription plan]

In an illustrative example, although it would be generally desirable that Networking should be fun, flexible and free, many people need or want to network but life can get in the way and it makes it difficult to set aside time to attend after work events. For example, Networking Events are very structured—everyone comes together at one place at a particular date and time (usually after work hours). People cannot always dedicate to these structured events for a multitude of reasons (work, kids, pets, family, commutes, etc.) So why does networking have to be so organized and structured? Why can't we network whenever we want? Why can I not network on my own schedule?

An embodiment Professionals in Motion app is an IOS and Android App Platform that will allow you to network with professionals in industries of your choice within a 50 mile radius of your phone. The App coordinates with your location services on your phone, your LinkedIn, Skype/facetime, the APP Cam Card and your calendar. The App is connected to your LinkedIn Profile and ONLY Linkedin (no FB or Insta). Allowing quick views of people's professional profiles. Upon setting up a “Promo Meetup”—the app will suggest coffee shops, bars, & restaurants in-between the two professionals meeting. When those meeting have their phones within 500 ft of each other a coupon is generated onto both phones for the food/drink location they decided on. You can “Promote Your ProMo Meetup” allowing others to join in on your meeting or “Stay Private” for uninterrupted one on one networking. Your digital business cards can be saved and sent through the app. If you do not have time to leave the office then you can elect to Video Conference as well using your phone or skype. Users can Select Free Time on another users Calendar to organize a meetup. Users can also select which free time on their calendar they would like to promote to the app. The App will find people with similar time slots in your area and suggest a meetup with them.

In some examples, the App has 3 options: Live (meaning you are open to network with someone right away), Taking Meeting (this will connect to your calendar—people can view your profile and if they want to meet with you they can select free time ranges within your calendar—you would get an alert and accept or deny the meetup), Offline (not seen on the map). No contact info—unless shared after meeting, no reviews. Some embodiments send a Follow Up Alert—for example, How′d the meetup go? Would you like to exchange information? Various designs provide an option to Share Business Cards, with Profile Page Buttons: Follow, Message, Meetup (Promo?), View LinkedIn Notifications in top right corner.

Some embodiments may include various features to monetize professional networking referrals, such as, for example: Premium Accounts—Can pay for your account to remain at the top of recommend people in the area to engage in a Promo Meetup (I.E. Higher premium restaurants); Local Businesses—Can Pay to show their company profile on the app, people interested in that businesses industry will see the companies profile when in the area; Restaurants/Bars/Coffee Shops—Can pay to be featured on the suggested list of locations for meetups. Various implementations may also provide a discount when an embodiment Promo Meetup barcode is shown at their location.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

The Abstract is provided to comply with 37 C. F. R. § 1.72(b), to allow the reader to quickly ascertain the nature of the technical disclosure and is submitted with the understanding that it will not be used to interpret or limit the scope or meaning of the claims.

In the present disclosure, all embodiments where “comprising” is used may have as alternatives “consisting essentially of” or “consisting of.” In the present disclosure, any method or apparatus embodiment may be devoid of one or more process steps or components. In the present disclosure, embodiments employing negative limitations are expressly disclosed and considered a part of this disclosure.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f). Elements recited in means-plus-function format are intended to be construed in accordance with 35 U.S.C. § 112 (f).

Recitation in a claim of the term “first” with respect to a feature or element does not necessarily imply the existence of a second or additional such feature or element.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects may lie in a combination of fewer than all features of any single foregoing disclosed embodiment. Thus, the claims following this Detailed Description are hereby expressly incorporated into this Detailed Description, with each claim standing on its own as a separate embodiment. This disclosure is to be interpreted as including all permutations of the independent claims with their dependent claims.

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

Various embodiments disclosed hereinabove may be summarized as follows.

### Embodiment 1

A computer-system implemented method for providing prospective networking referrals and arranging meetings between said referrals, the method comprising: extracting contact information of prospective networking referrals from a database based, at least in part, on whether the referrals work in a suggested or selected industry; accessing a calendar program that prompts each prospective networking referral to select available times for a networking meetup; displaying the prospective networking referrals along with their available meeting times; using the computer system to request a meetup with one or more of the prospective networking referrals; scheduling a meetup with a prospective networking referral that accepts the meetup request, wherein the meetup location is an agreed-upon location selected from a list of acceptable/preferred locations, wherein the list of acceptable locations comprise locations selected from among a list of suggested locations located between the meeting parties; transmitting the meetup location with directions to the meetup location to mobile electronic devices of each meeting party; providing a promotional coupon for use at the meeting location when the meeting parties are within a set proximity of each other; transmitting the promotional coupon to each of the meeting parties; and transmitting a post-meeting questionnaire to each of the meeting parties when they are beyond a set distance from each other.

### Embodiment 2

An apparatus, comprising: one or more processors; memory, operably connected with the one or more processors; and a program module, wherein the program module is stored in the memory and, during operation of the apparatus, is executed by the one or more processors to provide prospective networking referrals and arranging meetings between said referrals, including: instructions for extracting contact information of prospective networking referrals from a database based, at least in part, on whether the referrals work in a suggested or selected industry; instructions for accessing a calendar program that prompts each prospective networking referral to select available times for a networking meetup; instructions for displaying the prospective networking referrals along with their available meeting times; instructions for prompting a user to request a meetup with one or more of the prospective networking referrals; instructions for scheduling a meetup with a prospective networking referral that accepts the meetup request, wherein the meetup location is an agreed-upon location selected from a list of acceptable/preferred locations, wherein the list of acceptable locations comprise locations selected from among a list of suggested locations identified by the program module based on a condition that they are located between the meeting parties; instructions for transmitting the meetup location with directions to the meetup location to mobile electronic devices of each meeting party; instructions for providing a promotional coupon for use at the meeting location when the meeting parties are within a set proximity of each other; instructions for transmitting the promotional coupon to each of the meeting parties; and instructions for transmitting a post-meeting questionnaire to each of the meeting parties when they are beyond a set distance from each other.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A computer-system implemented method to generate prospective networking referrals and arrange meetings between the referrals, the method comprising:
extracting contact information of prospective networking referrals from a database, wherein the extraction is based, at least in part, on whether the referrals work in a suggested or selected industry;
accessing a calendar program that prompts each prospective networking referral to select available times for a networking meetup;
displaying the prospective networking referrals along with their available meeting times;
sending a meetup request to one or more of the prospective networking referrals;
scheduling a meetup with a prospective networking referral that accepts the meetup request, wherein the meetup location is an agreed-upon location selected from a list of acceptable locations, wherein the list of acceptable locations comprise locations selected from among a list of suggested locations located between the meeting parties;
transmitting the meetup location with directions to the meetup location to mobile electronic devices of each meeting party;
providing a promotional coupon for use at the meeting location when the meeting parties are within a set proximity of each other;
transmitting the promotional coupon to each of the meeting parties; and,
transmitting a post-meeting questionnaire to each of the meeting parties when they are beyond a set distance from each other.

2. The method of claim 1, wherein the method further comprises determining the user's networking goal based on profile data provided by the user.

3. The method of claim 1, wherein the user has a profile including a networking goal selected from the group consisting of hiring, seeking employment, or general networking.

4. The method of claim 1, wherein the user has a profile including a networking goal, and wherein the method further comprises determining the user's preferred time period to achieve the user's networking goal.

5. The method of claim 1, wherein the user has a networking goal, and wherein the user's networking goal further comprises meeting each of a list of desired potential networking contacts, wherein the list of desired potential networking contacts is provided by the user.

6. The method of claim 1, wherein extracting contact information of prospective networking referrals further comprises the prospective networking referrals extracted based on ranking the prospective referrals as a function of a list of desired potential networking contacts, and wherein prospective referrals the user has not met are ranked higher in preference to receive a networking request before lower-ranked prospective referrals.

7. The method of claim 1, wherein extracting contact information of prospective networking referrals further comprises the prospective networking referrals extracted based on ranking the prospective referrals as a function of skill set.

8. The method of claim 1, wherein extracting contact information of prospective networking referrals further comprises the prospective networking referrals extracted based on ranking the prospective referrals as a function of skill level determined based on a skill test score.

9. The method of claim 1, wherein extracting contact information of prospective networking referrals further comprises running an Artificial Intelligence (AI)/Machine Learning (ML) based matchmaking algorithm to identify prospective networking referrals.

10. An apparatus, comprising:
one or more processors;
memory, operably connected to the one or more processors; and,
a program module, wherein the program module is stored in the memory and, during operation of the apparatus, the program module is executed by the one or more processors to cause the one or more processors to perform operations to generate prospective networking referrals and arrange meetings between the referrals, the operations performed by the one or more processors comprising:
extract contact information of prospective networking referrals from a database, wherein the extraction is based, at least in part, on whether the referrals work in a suggested or selected industry;
determining the user's networking goal based on profile data provided by the user;
running an Artificial Intelligence (AI)/Machine Learning (ML) based matchmaking algorithm to identify prospective networking referrals selected as a function of the user's networking goal;
access a calendar program that prompts each identified prospective networking referral to select available times for a networking meetup;
display the prospective networking referrals along with their available meeting times;
prompt the user to request a meetup with one or more prospective networking referral;
schedule a meetup with a prospective networking referral that accepts the meetup request, wherein the meetup location is an agreed-upon location selected from a list of acceptable locations, wherein the list of acceptable locations comprise locations selected from among a list of suggested locations identified by the program module based on a condition that they are located between the meeting parties;
transmit the meetup location with directions to the meetup location to mobile electronic devices of each meeting party;
provide a promotional coupon for use at the meeting location when the meeting parties are within a set proximity of each other;
transmit the promotional coupon to each of the meeting parties; and,
transmit a post-meeting questionnaire to each of the meeting parties when they are beyond a set distance from each other.

11. The apparatus of claim 10, wherein the user's networking goal further comprises meeting each of a list of desired potential networking contacts.

12. The apparatus of claim 10, wherein the Artificial Intelligence (AI)/Machine Learning (ML) based matchmaking algorithm further comprises matching selected prospective networking referrals based on skill set and skill level.

13. The apparatus of claim 10, wherein the operations performed by the one or more processors further comprise: determining if the promotional coupon was not redeemed during the scheduled meeting; and, in response to a determination the promotional coupon was not redeemed, adding the promotional coupon value to a reward points account accessible by the promotional coupon recipient.

14. The apparatus of claim 10, wherein the operations performed by the one or more processors further comprise excluding from the selected prospective networking referrals a prospective referral the user indicated they do not want to network with.

15. An apparatus, comprising:
one or more processors;
memory, operably connected to the one or more processors; and,
a program module, wherein the program module is stored in the memory and, during operation of the apparatus, the program module is executed by the one or more processors to cause the one or more processors to perform operations to generate prospective networking referrals and arrange meetings between the referrals, the operations performed by the one or more processors comprising:
extract contact information of prospective networking referrals from a database, wherein the extraction is based, at least in part, on whether the referrals work in a suggested or selected industry;
determining the user's networking goal based on profile data provided by the user;
running an Artificial Intelligence (AI)/Machine Learning (ML) based matchmaking algorithm to identify prospective networking referrals selected based on the prospective referrals ranked as a function of the user's networking goal;
access a calendar program that prompts each identified prospective networking referral to select available times for a networking meetup;
display the prospective networking referrals along with their available meeting times;
prompt the user to request a meetup with one or more prospective networking referral;
schedule a meetup with a prospective networking referral that accepts the meetup request, wherein the meetup location is an agreed-upon location selected from a list of acceptable locations, wherein the list of acceptable locations comprise locations selected from among a list of suggested locations identified by the program module based on a condition that they are located between the meeting parties;
transmit the meetup location with directions to the meetup location to mobile electronic devices of each meeting party;
provide a promotional coupon for use at the meeting location when the meeting parties are within a set proximity of each other;
transmit the promotional coupon to each of the meeting parties;
transmit a post-meeting questionnaire to each of the meeting parties when they are beyond a set distance from each other;
determine if the promotional coupon was not redeemed during the scheduled meeting; and,
in response to a determination the promotional coupon was not redeemed, adding the promotional coupon value to a reward points account accessible by the promotional coupon recipient.

16. The apparatus of claim 15, wherein the list of suggested locations identified by the program module further comprise a location selected as a function of user venue preference.

17. The apparatus of claim 15, wherein the operations performed by the one or more processors further comprise implementation of an application mode selected from the group consisting of offline, online seeking networking opportunities, and taking meetings.

18. The apparatus of claim 15, wherein the operations performed by the one or more processors further comprise prospective networking referrals ranked as a function of skill test score normalized to skill test scores collected from a geographic region.

19. The apparatus of claim 15, wherein the operations performed by the one or more processors further comprise hiding employer company names from view in a user's profile.

20. The apparatus of claim 15, wherein the promotional coupon further comprises an offer to donate a portion of the promotional coupon value to charity.
